(19) United States
(12) Patent Application Publication
(10) Pub. No.: US 2026/0317204 A1
(43) Pub. Date: Oct. 15, 2026

(54) WASTEWATER TREATMENT APPARATUS

(71) Applicant: SAMSUNG ELECTRONICS CO., LTD., Suwon-si (KR)

(72) Inventors: Seungbae OH, Suwon-si (KR); Wooram LEE, Suwon-si (KR); Jong Kwon CHOE, Seoul-si (KR); Seohyun KIM, Seoul-si (KR); Heegu KIM, Seoul-si (KR); Yerin CHOE, Seoul-si (KR); Minji KIM, Suwon-si (KR); Eunji KIM, Suwon-si (KR); Jehun KIM, Suwon-si (KR); Soojin SHIM, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/572,392

(22) Filed: Mar. 19, 2026

(30) Foreign Application Priority Data
Apr. 15, 2025 (KR) 10-2025-0049148

(51) Int. Cl. C02F 1/32; C02F 1/66; C02F 1/70; C02F 101/36

(52) U.S. Cl. CPC C02F 1/32; C02F 1/66; C02F 1/70; C02F 2101/36

(57) ABSTRACT

A wastewater treatment apparatus includes a wastewater storage assembly configured to store wastewater including per- and polyfluoroalkyl substances (PFAS), a reducing agent mixer configured to add and mix a reducing agent into the wastewater, a pH adjuster configured to add a pH adjusting agent to the wastewater and adjust a pH, a dissolved oxygen remover configured to remove dissolved oxygen from the wastewater, and a reactor configured to radiate ultraviolet rays to the wastewater and decompose the PFAS in the wastewater, and a final treated water storage assembly configured to store the wastewater in which the PFAS are decomposed.

### CROSS-REFERENCE TO RELATED APPLICATION

This application is based on and claims priority under 35 U.S.C. § 119 to Korean Patent Application No. 10-2025-0049148, filed on Apr. 15, 2025, in the Korean Intellectual Property Office, the disclosure of which is incorporated by reference herein in its entirety.

### BACKGROUND

The disclosure relates to a wastewater treatment apparatus, and more particularly, relates to a wastewater treatment apparatus treating wastewater including per- and polyfluoroalkyl substances (PFAS).

In general, semiconductor devices are manufactured through a deposition process, a photolithography process, an ion implantation process, a polishing process, a cleaning process, etc. Various chemical agents are used in these processes. Therefore, after the above processes are completed, wastewater including components of the chemical agents, such as PFAS, is generated.

### SUMMARY

The disclosure provides a wastewater treatment apparatus capable of decomposing and removing per- and polyfluoroalkyl substances (PFAS) in wastewater.

However, the problems to be solved by the disclosure are not limited to the problems mentioned above, and other problems may be clearly understood by those skilled in the art from the following description.

According to an aspect of the disclosure, there is provided a wastewater treatment apparatus including a wastewater storage assembly configured to store wastewater including per- and polyfluoroalkyl substances (PFAS), a reducing agent mixer configured to introduce and mix a reducing agent into the wastewater, a pH adjuster configured to introduce a pH adjusting agent into the wastewater and adjust a pH of the wastewater, a dissolved oxygen remover configured to remove dissolved oxygen from the wastewater, a reactor configured to radiate ultraviolet rays to the wastewater to decompose the PFAS in the wastewater, and a final treated water storage assembly configured to store the wastewater in which the PFAS have been decomposed.

According to an aspect of the disclosure, there is provided a wastewater treatment apparatus including a wastewater storage assembly configured to store wastewater, a reducing agent mixer configured to introduce and mix a reducing agent including a sulfite compound into the wastewater, a pH adjuster configured to introduce a pH adjusting agent to the wastewater and adjust a pH of the wastewater to an alkaline level, a dissolved oxygen remover configured to aerate nitrogen gas into the wastewater to remove dissolved oxygen, a reactor configured to radiate ultraviolet rays to the wastewater to decompose specific substances included in the wastewater, and a final treated water storage assembly configured to store the wastewater in which the specific substances have been decomposed.

According to an aspect of the disclosure, there is provided a wastewater treatment apparatus including a wastewater storage assembly configured to store wastewater including Bis(1,1,2,2,3,3,4,4,4-nonafluoro-1-butanesulfonyl)imide, a reducing agent mixer configured to introduce and mix a reducing agent including a sulfite compound into the wastewater, a reactor configured to radiate ultraviolet rays to the wastewater and decompose the Bis(1,1,2,2,3,3,4,4,4-nonafluoro-1-butanesulfonyl)imide included in the wastewater, and a final treated water storage assembly configured to store the wastewater in which the Bis(1,1,2,2,3,3,4,4,4-nonafluoro-1-butanesulfonyl)imide has been decomposed.

According to an aspect of the disclosure, there is provided a wastewater treatment method including collecting and storing wastewater, introducing and mixing a reducing agent into the wastewater, adjusting a pH by introducing a pH adjusting agent to the wastewater, removing dissolved oxygen from the wastewater, radiating ultraviolet rays to the wastewater, and storing final treated water.

In an embodiment, the final treated water may have a lower concentration of PFAS than the wastewater.

In an embodiment, the final treated water may have a lower concentration of Bis(1,1,2,2,3,3,4,4,4-nonafluoro-1-butanesulfonyl)imide than the wastewater.

In an embodiment, the reducing agent may include sodium bisulfite (NaHSO₃), sodium sulfite (Na₂SO₃), potassium sulfite (K₂SO₃), potassium bisulfite (KHSO₃), ammonium sulfite ((NH₄)₂SO₃), ammonium bisulfite (NH₄HSO₃), calcium sulfite (CaSO₃), or a combination thereof.

In an embodiment, the reducing agent may be introduced at a concentration within the range of about 5 mM to about 20 mM (the term “about” means±5% for purposes of this specification).

In an embodiment, the pH adjusting agent may include sodium hydroxide (NaOH), calcium hydroxide (Ca(OH)₂), potassium hydroxide (KOH), ammonia water (NH₄OH), magnesium hydroxide (Mg(OH)₂), barium hydroxide (Ba(OH)₂), or a combination thereof.

In an embodiment, the pH adjusting agent may be introduced until the pH reaches a value within the range of about 10 to about 12.

In an embodiment, in the removing of the dissolved oxygen from the wastewater, nitrogen gas (N₂) may be aerated into the wastewater.

In an embodiment, nitrogen gas (N₂) may be aerated within the range of about 0.2 kg/min to about 0.3 kg/min per unit volume (1 m³) of the wastewater for about 10 minutes to about 40 minutes.

In an embodiment, the ultraviolet rays may have a wavelength within the range of about 200 nm to about 280 nm.

In an embodiment, the ultraviolet rays may be radiated within the range of about 20 W/cm² to about 30 W/cm².

### BRIEF DESCRIPTION OF THE DRAWINGS

Embodiments will be more clearly understood from the following detailed description taken in conjunction with the accompanying drawings in which:

FIG. 1 is a schematic diagram for describing a wastewater treatment apparatus of the disclosure; and

FIG. 2 is a flowchart illustrating a wastewater treatment method of the disclosure.

### DETAILED DESCRIPTION

Hereinafter, embodiments are described in detail with reference to the accompanying drawings. Like reference numerals in the drawings denote like components, and thus their repetitive description will be omitted.

Certain structural or functional descriptions of the embodiments disclosed herein are illustrated only for the purpose of describing the embodiments, and the embodiments may be implemented in various forms and should not be construed as being limited to the embodiments described herein.

As the disclosure allows for various changes and numerous embodiments, certain embodiments will be illustrated in the drawings and described in the detailed description. However, it should be appreciated that this is not intended to limit the disclosure to a particular embodiment, and includes all changes, equivalents, or alternatives included in the idea and technical scope of the disclosure.

Terms such as first and second may be used to describe various components, but the components should not be limited by the above terms. The terms are used only for the purpose of distinguishing one component from another component. For example, the first component may be referred to as a second component without departing from the scope of the disclosure, and similarly, the second component may be referred to as a first component.

When one component is “connected” or “coupled” to the other component, it is understood that the one component may be directly connected to or may be directly coupled to the other component but unless explicitly described to the contrary, may be “connected” or “coupled” to the other component through another component therebetween. On the other hand, when one component is “directly connected” or “directly coupled” to another component, it should be understood that no other component exists therebetween. Other expressions that describe the relationship between components, such as “between” and “just between” or “adjacent to” and “directly adjacent to” should also be interpreted in the same manner.

The terms used herein are used only to describe specific embodiments and are not intended to limit the disclosure. An expression used in the singular may encompass the expression of the plural, unless it has a clearly different meaning in the context. Herein, the terms “include” or “have” are intended to specify the presence of features, numbers, steps, operations, components, parts, or a combination thereof, but should be understood not to preclude the presence or addition of one or more other features, numbers, steps, operations, components, parts, or combinations thereof.

Unless otherwise defined, all terms including technical or scientific terms used herein may have the same meanings as commonly understood by one of ordinary skill in the art to which the disclosure belongs. Terms such as those commonly used dictionaries should be interpreted as having a meaning consistent with the meaning of the context of the relevant technology, and unless explicitly defined herein, they are not interpreted in an ideal or excessively formal sense.

Here, the meaning of “removed” should be interpreted to include not only the complete removal of a substance from water to be treated, but also the partial removal of a substance from the water to be treated.

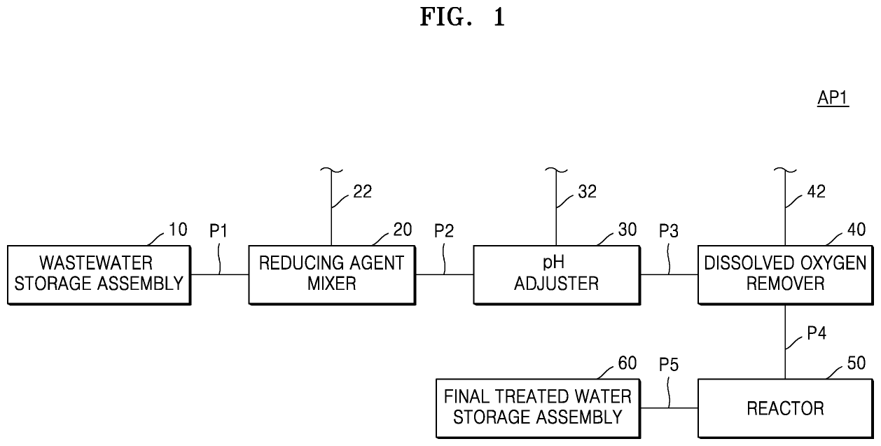

FIG. 1 is a schematic diagram for describing a wastewater treatment apparatus AP1 of the disclosure.

Referring to FIG. 1, the wastewater treatment apparatus AP1 of the disclosure may include a wastewater storage assembly 10, a reducing agent mixer 20, a pH adjuster 30, a dissolved oxygen remover 40, a reactor 50, and a final treated water storage assembly 60.

The wastewater storage assembly 10 may be connected to the reducing agent mixer 20 through a first pipe P1, the reducing agent mixer 20 may be connected to the pH adjuster 30 through a second pipe P2, the pH adjuster 30 may be connected to the dissolved oxygen remover 40 through a third pipe P3, the dissolved oxygen remover 40 may be connected to the reactor 50 through a fourth pipe P4, and the reactor 50 may be connected to the final treated water storage assembly 60 through a fifth pipe P5.

In some embodiments, although not shown, each of the first to fifth pipes P1, P2, P3, P4, and P5 may include a wastewater supply pump transferring wastewater to a subsequent unit. In addition, in some embodiments, although not shown, each of the first to fifth pipes P1, P2, P3, P4, and P5 may include an opening/closing valve opening and closing the first to fifth pipes P1, P2, P3, P4, and P5 so as to prevent backflow after transferring wastewater to the subsequent unit.

In embodiments, the wastewater storage assembly 10 may store wastewater. The wastewater storage assembly 10 may include a storage tank storing wastewater, and the storage tank may include an appropriate material for storing wastewater. The wastewater, which is semiconductor wastewater, may include components included in various chemical agents used in a process for manufacturing a semiconductor device.

In embodiments, the wastewater may include per- and polyfluoroalkyl substances (PFAS). For example, in order to manufacture a semiconductor device, an etching process using a perfluorocarbon plasma etching gas or a cleaning process using a fluorine-based cleaning solution may be performed, and wastewater generated by the etching process and the cleaning process may include the PFAS. In addition, wastewater generated by a photolithography process, an electrolytic plating process, and a wiring process may also include the PFAS. In some embodiments, the wastewater may include Bis(1,1,2,2,3,3,4,4,4-nonafluoro-1-butanesulfonyl)imide. The PFAS have high heat resistance and chemical resistance, and generally do not decompose well, and thus are substances that are harmful to the environment.

The wastewater storage assembly 10 may store wastewater at room temperature. The wastewater stored in the wastewater storage assembly 10 may have a temperature within the range of 10 degrees Celsius to 30 degrees Celsius.

In some embodiments, the wastewater storage assembly 10 may include a flow meter. For example, the flow meter may measure a volume flow rate of the wastewater by measuring a volume of the wastewater flowing per unit time. As another example, the flow meter may measure a mass flow rate of the wastewater by measuring a mass of the wastewater flowing per unit time. As the flow meter, for example, a differential pressure flow meter, a turbine flow meter, an ultrasonic flow meter, a rotor meter, etc. may be used. The flow meter may be provided on the first pipe P1 between the wastewater storage assembly 10 and the reducing agent mixer 20 to measure a flow rate of the wastewater transferred from the wastewater storage assembly 10 to the reducing agent mixer 20.

The reducing agent mixer 20 may be connected to the wastewater storage assembly 10 and receive the wastewater from the wastewater storage assembly 10.

The reducing agent mixer 20 may be connected to a reducing agent supply line 22. The reducing agent mixer 20 may receive a reducing agent from the reducing agent supply line 22, and introduce and mix the reducing agent into the wastewater. The reducing agent mixer 20 may include a mixing tank and a stirring device mixing wastewater and the reducing agent, and the mixing tank may include an appropriate material so that the wastewater and the reducing agent may be mixed. The reducing agent supply line 22 may be connected to a reducing agent storage tank storing the reducing agent.

The reducing agent mixed with the wastewater in the reducing agent mixer 20 may include a sulfite compound. For example, the sulfite compound may include sodium bisulfite (NaHSO₃), sodium sulfite (Na₂SO₃), potassium sulfite (K₂SO₃), potassium bisulfite (KHSO₃), ammonium sulfite ((NH₄)₂SO₃), ammonium bisulfite (NH₄HSO₃), calcium sulfite (CaSO₃), or a combination thereof.

The reducing agent may be introduced in a solid or aqueous solution state. The reducing agent may be ionized after dissolving in the wastewater. The reducing agent includes a sulfite compound, thereby forming sulfite ions (SO₃²⁻) after dissolving in the wastewater. For example, the reducing agent including sodium sulfite may form sodium ions (Na⁺) and sulfite ions (SO₃²⁻).

The reducing agent may be introduced at a concentration within the range of about 5 mM to about 20 mM. In order to adjust the concentration of the reducing agent to within the range of about 5 mM to about 20 mM, the volume of the wastewater may be measured from the flow meter, an input amount of the reducing agent may be calculated from the volume of the wastewater so that the reducing agent may be introduced at the concentration of about 5 mM to about 20 mM, and the reducing agent may be introduced to the wastewater by the calculated input amount. The introduction concentration of the reducing agent may be adjusted to an appropriate concentration by monitoring a degree of decomposition of the PFAS.

A hydraulic retention time (HRT) in the reducing agent mixer 20 may be within the range of about 5 minutes to about 15 minutes, about 10 minutes to about 20 minutes, or about 15 minutes to about 30 minutes.

The pH adjuster 30 may be connected to the reducing agent mixer 20 and receive the wastewater mixed with the reducing agent from the reducing agent mixer 20.

The pH adjuster 30 may be connected to a pH adjusting agent supply line 32. The pH adjuster 30 may receive a pH adjusting agent from the pH adjusting agent supply line 32 and introduce the pH adjusting agent to the wastewater mixed with the reducing agent. The pH adjuster 30 may include a mixing tank and a stirring device mixing the wastewater and the pH adjusting agent, and the mixing tank may include an appropriate material so that the wastewater and the pH adjusting agent may be mixed. The pH adjusting agent supply line 32 may be connected to a pH adjusting agent storage tank storing the pH adjusting agent.

The pH adjusting agent introduced to the wastewater mixed with the reducing agent in the pH adjuster 30 may include a basic compound. For example, the pH adjusting agent may include sodium hydroxide (NaOH), calcium hydroxide (Ca(OH)₂), potassium hydroxide (KOH), ammonia water (NH₄OH), magnesium hydroxide (Mg(OH)₂), barium hydroxide (Ba(OH)₂), or a combination thereof. The pH adjusting agent may include a strongly basic compound.

The pH adjusting agent may be introduced in a solid or aqueous solution state. The pH adjusting agent may be ionized after dissolving in the wastewater. The pH adjusting agent includes the strongly basic compound, thereby forming hydroxide ions (OH) after dissolving in the wastewater. For example, sodium hydroxide (NaOH) may form sodium ions (Na⁺) and hydroxide ions (OH⁻) after dissolving in the wastewater.

The pH adjuster 30 may include a pH measuring device measuring pH of the wastewater. The pH adjuster 30 may introduce the pH adjusting agent so that the pH of the wastewater becomes an alkaline level, that is, the pH has a value within the range of about 7 to about 14. For example, the pH adjusting agent may be introduced until the pH reaches about 11. The pH measuring device may monitor a pH concentration of the wastewater and control an input concentration of the pH adjusting agent based on the monitored pH concentration.

An HRT in the pH adjuster 30 may be within the range of about 5 minutes to about 15 minutes, about 10 minutes to about 20 minutes, or about 15 minutes to about 30 minutes.

When the pH of the wastewater is acidic, hydration electrons (e⁻) generated from the sulfite ion (SO₃²⁻) in the reactor 50 react with hydrogen ions (H⁺) and then are removed, and thus the PFAS may not be removed relatively smoothly. Therefore, the pH of the wastewater may be adjusted to be an alkaline level by introducing the pH adjusting agent, thereby preventing hydration electrons (e⁻) from being removed.

The dissolved oxygen remover 40 may be connected to the pH adjuster 30 and receive the wastewater mixed with the reducing agent and the pH adjusting agent from the pH adjuster 30.

In some embodiments, the dissolved oxygen remover 40 may be connected to nitrogen gas supply line 42. The dissolved oxygen remover 40 may remove dissolved oxygen by receiving nitrogen gas (N₂) from the nitrogen gas supply line 42 and aerating the nitrogen gas (N₂) in the wastewater (i.e., adding the nitrogen gas into the wastewater). The dissolved oxygen remover 40 may include a device capable of generating fine nitrogen bubbles so as to remove dissolved oxygen by aerating the nitrogen gas (N₂). However, the dissolved oxygen remover 40 is not limited to removing dissolved oxygen by aerating nitrogen gas (N₂), but may remove dissolved oxygen by using various methods such as vacuum degassing of dissolved oxygen by vacuum degassing the wastewater, steam aeration, or membrane degassing of dissolved oxygen by using a gas permeable membrane.

In some embodiments, so as to remove dissolved oxygen by aerating nitrogen gas (N₂), the dissolved oxygen remover 40 may aerate nitrogen gas (N₂) at a rate within the range of about 0.2 kg/min to about 0.3 kg/min, about 0.3 kg/min to about 0.4 kg/min, or about 0.4 kg/min to about 0.5 kg/min per unit volume (1 m³) of the wastewater. However, an introduction amount (aeration amount) of nitrogen gas (N₂) per minute by the dissolved oxygen remover 40 is not limited to a value within the described range, and may be adjusted to an appropriate value to remove the dissolved oxygen from the wastewater.

An HRT in the dissolved oxygen remover 40 may be within the range of about 10 minutes to about 40 minutes, about 20 minutes to about 50 minutes, or about 30 minutes to about 60 minutes.

When dissolved oxygen remains, the hydration electrons (e⁻) generated from the sulfite ion (SO₃²⁻) in the reactor 50 react with the dissolved oxygen and then are removed, and thus the PFAS may not be removed relatively smoothly. Therefore, the dissolved oxygen in the wastewater may be removed as much as possible.

The reactor 50 may be connected to the dissolved oxygen remover 40 and receive wastewater from which the dissolved oxygen has been removed from the dissolved oxygen remover 40.

The reactor 50 may include an ultraviolet lamp radiating ultraviolet rays to the wastewater. The ultraviolet lamp may include, for example, a low pressure mercury lamp (LPML).

The ultraviolet rays radiated from the reactor 50 may have a wavelength within the range of about 200 nm to about 280 nm, for example, about 250 nm to about 260 nm or about 254.

The ultraviolet rays may be radiated at an intensity within the range of about 20 W/cm² to about 30 W/cm² or about 30 W/cm² to about 40 W/cm² from the reactor 50. However, the intensity of the ultraviolet rays radiated from the reactor 50 is not limited to a value within the described range, and may be appropriately adjusted for decomposition of the PFAS.

The ultraviolet rays may react with sulfite ions (SO₃²⁻) in the wastewater and generate hydration electrons (e⁻). A reaction in which the ultraviolet rays react with sulfite ions (SO₃²⁻) in the wastewater and generate hydration electrons (e⁻) may be represented by Reaction Equation 1 below.

SO₃²⁻→SO₃⋅⁻+e⁻ [Reaction Equation 1]

In Reaction Equation 1, it may be seen that when the ultraviolet rays are radiated to sulfite ions (SO₃²⁻), sulfite radical (SO₃⋅⁻) and hydration electrons (e⁻) are formed.

The generated hydration electrons (e⁻) may cause a chain oxidation-reduction reaction with the PFAS and water (H₂O), and the PFAS may be decomposed by the chain oxidation-reduction reaction. For example, the generated hydration electrons (e⁻) may cause the chain oxidation-reduction reaction with Bis(1,1,2,2,3,3,4,4,4-nonafluoro-1-butanesulfonyl)imide and water (H₂O), and the Bis(1,1,2,2,3,3,4,4,4-nonafluoro-1-butanesulfonyl)imide may be decomposed by the chain oxidation-reduction reaction.

The decomposition of the PFAS and the decomposition of Bis(1,1,2,2,3,3,4,4,4-nonafluoro-1-butanesulfonyl)imid are described below in detail with reference to an experimental example.

An HRT in the reactor 50 may be within the range of about 5 minutes to about 120 minutes or about 10 minutes to about 150 minutes.

The final treated water storage assembly 60 may be connected to the reactor 50 and receive wastewater, that is, final treated water, from which the PFAS have been decomposed and removed from the reactor 50. The final treated water may have a lower concentration of the PFAS than the initial wastewater. For example, the final treated water may have a lower concentration of Bis(1,1,2,2,3,3,4,4,4-nonafluoro-1-butanesulfonyl)imide than the initial wastewater.

The final treated water storage assembly 60 may include a PFAS concentration measuring device monitoring the concentration of the PFAS remaining in the final treated water.

The concentration of the PFAS remaining in the final treated water may be monitored through the PFAS concentration measuring device, and thus the introduction concentration of the reducing agent in the reducing agent mixer 20, the introduction concentration of the pH adjusting agent in the pH adjuster 30, and the injection amount of the nitrogen gas (N₂) per minute in the dissolved oxygen remover 40 may be appropriately adjusted. In addition, the HRT in each of the reducing agent mixer 20, the pH adjuster 30, the dissolved oxygen remover 40, and the reactor 50 is not limited to the time within the described range, and may be appropriately adjusted by monitoring concentration of the PFAS remaining in the final treated water through the PFAS concentration measuring device.

In some embodiments, the HRT in the reactor 50 may be greater than the HRT of each of the reducing agent mixer 20, the pH adjuster 30, and the dissolved oxygen remover 40. In some embodiments, the HRT in the dissolved oxygen remover 40 may be greater than the HRT in each of the reducing agent mixer 20 and the pH adjuster 30. The HRT in each of the reducing agent mixer 20 and the pH adjuster 30 may be less than the HRT in the dissolved oxygen remover 40 and the reactor 50.

Hereinafter, whether Bis(1,1,2,2,3,3,4,4,4-nonafluoro-1-butanesulfonyl)imide is removed from the wastewater and removal conditions of Bis(1,1,2,2,3,3,4,4,4-nonafluoro-1-butanesulfonyl)imide are confirmed with reference to an experimental example and a comparative example below.

### EXPERIMENTAL EXAMPLE

Wastewater including Bis(1,1,2,2,3,3,4,4,4-nonafluoro-1-butanesulfonyl)imide was collected in the wastewater storage assembly 10, the collected wastewater was transferred to the reducing agent mixer 20, sodium sulfite (Na₂SO₃) of a concentration of 10 mM was introduced and mixed for 15 minutes, and then the wastewater mixed with sodium sulfite (Na₂SO₃) was transferred to the pH adjuster 30. The pH adjuster 30 introduced sodium hydroxide (NaOH) to the wastewater mixed with sodium sulfite (Na₂SO₃) until the pH was within the range of 10 to 11, and the wastewater mixed with sodium hydroxide (NaOH) was transferred to the dissolved oxygen remover 40. The dissolved oxygen remover 40 aerated nitrogen gas (N₂) of 0.24 kg/min per wastewater unit volume (1 m³) for about 30 minutes, and dissolved oxygen was removed, and then the wastewater from which the dissolved oxygen had been removed was transferred to the reactor 50. An ultraviolet lamp of the reactor 50 radiated ultraviolet rays having a wavelength of 254 nm at 28.8 W/cm² for about 120 minutes to the wastewater from which the dissolved oxygen had been removed, and removal rates of Bis(1,1,2,2,3,3,4,4,4-nonafluoro-1-butanesulfonyl)imide according to time were confirmed. The reaction temperature was maintained at 25 degrees Celsius. The removal rates of Bis(1,1,2,2,3,3,4,4,4-nonafluoro-1-butanesulfonyl)imide according to time are shown in Table 1 below.

TABLE 1

| | Removal rates (%) of |
|---|---|
| Ultraviolet rays radiation time | Bis(1,1,2,2,3,3,4,4,4-nonafluoro-1- |
| (minutes) | butanesulfonyl)imide |
| 0 | 0 |
| 5 | 11 |
| 10 | 23 |
| 15 | 32 |
| 30 | 66 |
| 60 | 97 |
| 120 | 100 |

### Comparative Example

As a comparative example, sodium sulfite (Na₂SO₃) was not introduced to the wastewater including Bis(1,1,2,2,3,3,4,4,4-nonafluoro-1-butanesulfonyl)imide, an ultraviolet lamp radiated ultraviolet rays having a wavelength of 254 nm at 28.8 W/cm² for about 120 minutes as in the Experimental Example, and removal rates of Bis(1,1,2,2,3,3,4,4,4-nonafluoro-1-butanesulfonyl)imide according to time were confirmed. The reaction temperature was maintained at 25 degrees Celsius. The removal rates of Bis(1,1,2,2,3,3,4,4,4-nonafluoro-1-butanesulfonyl)imide according to time are shown in Table 2 below.

TABLE 2

| | Removal rates (%) of |
|---|---|
| Ultraviolet rays radiation time | Bis(1,1,2,2,3,3,4,4,4-nonafluoro-1- |
| (minutes) | butanesulfonyl)imide |
| 0 | 0 |
| 5 | 0 |
| 10 | 0 |
| 15 | 0 |
| 30 | 0 |
| 60 | 0 |
| 120 | 0 |

Referring to Tables 1 and 2, it may be seen that when sodium sulfite (Na₂SO₃) as a reducing agent is not introduced to the wastewater, Bis(1,1,2,2,3,3,4,4,4-nonafluoro-1-butanesulfonyl)imide in the wastewater is not removed. In other words, it may be seen that Bis(1,1,2,2,3,3,4,4,4-nonafluoro-1-butanesulfonyl)imide in the wastewater is removed when sodium sulfite (Na₂SO₃) as a reducing agent providing hydration electrons (e⁻) is introduced to the wastewater, and ultraviolet rays are radiated to the wastewater so that sodium sulfite (Na₂SO₃) may generate sulfite radicals (SO₃⋅⁻) and hydration electrons (e⁻).

In related art, wastewater including the PFAS was passed into a granular activated carbon (GAC) tower, the PFAS was absorbed onto GAC, and then the GAC adsorbed with the PFAS was buried or incinerated.

However, because the PFAS is adsorbed onto the GAC by the van der Waals force, there was a risk of desorption, and there was a problem that waste activated carbon adsorbed with the PFAS is difficult to treat.

According to the wastewater treatment apparatus AP1 according to embodiments, the PFAS may be decomposed in and removed from the wastewater including the PFAS without generating waste such as waste activated carbon and waste concentrated water, thereby solving the risk of the PFAS being desorbed from the GAC and the problem of being difficult to treat waste activated carbon adsorbed with the PFAS, and eliminating environmental pollution caused by the wastewater.

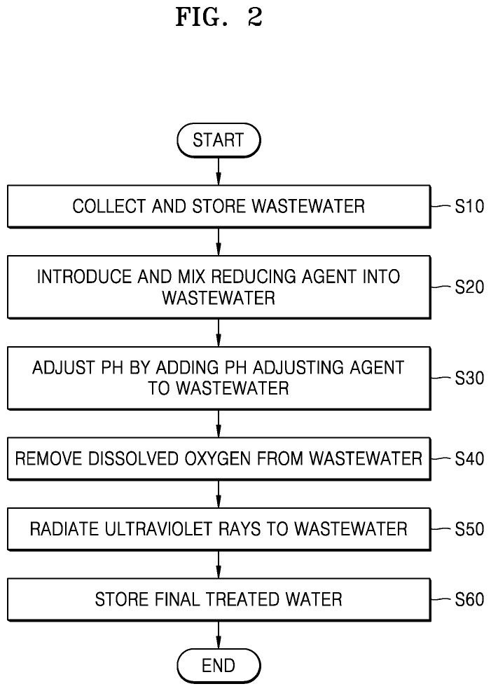

FIG. 2 is a flowchart illustrating a wastewater treatment method of the disclosure.

Referring to FIG. 2, the wastewater treatment method of the disclosure may include operation S10 of collecting and storing wastewater, operation S20 of introducing and mixing a reducing agent into the wastewater, operation S30 of adjusting a pH by introducing a pH adjusting agent to the wastewater, operation S40 of removing dissolved oxygen from the wastewater, operation S50 of radiating ultraviolet rays to the wastewater, and operation S60 of storing final treated water.

In operation S10 of collecting and storing the wastewater, the wastewater, which is semiconductor wastewater, may include components included in various chemical agents used in a process for manufacturing a semiconductor device.

In embodiments, the wastewater may include PFAS. For example, the wastewater may include Bis(1,1,2,2,3,3,4,4,4-nonafluoro-1-butanesulfonyl)imide.

Thereafter, operation S20 of introducing and mixing the reducing agent into the wastewater may be performed. The reducing agent mixed with the wastewater may include a sulfite compound. For example, the sulfite compound may include sodium bisulfite (NaHSO₃), sodium sulfite (Na₂SO₃), potassium sulfite (K₂SO₃), potassium bisulfite (KHSO₃), ammonium sulfite ((NH₄)₂SO₃), ammonium bisulfite (NH₄HSO₃), calcium sulfite (CaSO₃), or a combination thereof.

The reducing agent may be introduced in a solid or aqueous solution state. The reducing agent may be ionized after dissolving in the wastewater. The reducing agent includes the sulfite compound, thereby forming sulfite ions (SO₃²⁻) after dissolving in the wastewater.

The reducing agent may be introduced at a concentration within the range of about 5 mM to about 20 mM. However, the introduction concentration of the reducing agent may be adjusted to an appropriate concentration by monitoring a degree of decomposition of the PFAS. The time for introducing and mixing the reducing agent into the wastewater may be within the range of about 5 minutes to about 15 minutes, about 10 minutes to about 20 minutes, or about 15 minutes to about 30 minutes. However, the time for introducing and mixing the reducing agent into the wastewater may be adjusted to an appropriate time by monitoring the degree of decomposition of the PFAS.

Thereafter, operation S30 of adjusting the pH by introducing the pH adjusting agent to the wastewater may be performed. The pH adjusting agent may include a basic compound. For example, the pH adjusting agent may include sodium hydroxide (NaOH), calcium hydroxide (Ca(OH)₂), potassium hydroxide (KOH), ammonia water (NH₄OH), magnesium hydroxide (Mg(OH)₂), barium hydroxide (Ba(OH)₂), or a combination thereof. The pH adjusting agent may include a strongly basic compound.

The pH adjusting agent may be introduced in a solid or aqueous solution state. The pH adjusting agent may be ionized after dissolving in the wastewater. The pH adjusting agent includes the strongly basic compound, thereby forming hydroxide ions (OH) after dissolving in the wastewater. The pH adjusting agent may be introduced until the pH of the wastewater has a value within the range of about 7 to about 14. For example, the pH adjusting agent may be introduced until the pH reaches a value within the range of about 10 to about 12. For example, the pH adjusting agent may be introduced until the pH reaches about 11. However, the introduction concentration of the pH adjusting agent may be adjusted to an appropriate concentration by monitoring the degree of decomposition of the PFAS. The time for introducing and mixing the pH control agent may be within the range of about 5 minutes to about 15 minutes, about 10 minutes to about 20 minutes, or about 15 minutes to about 30 minutes. However, the time for introducing and mixing the pH adjusting agent may be adjusted to an appropriate time by monitoring the degree of decomposition of the PFAS.

Operation S30 of adjusting the pH by introducing the pH adjusting agent to the wastewater may reduce or prevent hydration electrons (e⁻) generated when operation S50 of radiating ultraviolet rays to the wastewater is performed from being removed by reacting with hydrogen ions (H⁺), thereby more efficiently removing the PFAS from the wastewater.

Thereafter, operation S40 of removing the dissolved oxygen in the wastewater may be performed. In some embodiments, nitrogen gas (N₂) may be aerated into the wastewater so as to remove the dissolved oxygen from the wastewater. For example, nitrogen gas (N₂) may be aerated within the range of about 0.2 kg/min to about 0.3 kg/min, about 0.3 kg/min to about 0.4 kg/min, or about 0.4 kg/min to about 0.5 kg/min per unit volume (1 m³) of the wastewater. However, an introduction amount (aeration amount) of nitrogen gas (N₂) per minute is not limited to a value within the described range, and may be adjusted to an appropriate value to remove the dissolved oxygen from the wastewater by monitoring the degree of decomposition of the PFAS. The time for removing the dissolved oxygen from the wastewater may be within the range of about 10 minutes to about 40 minutes, about 20 minutes to about 50 minutes, or about 30 minutes to about 60 minutes. The time for removing the dissolved oxygen from the wastewater may be longer than at least the time for introducing and mixing the reducing agent and the time for introducing and mixing the pH adjusting agent. However, the time for removing the dissolved oxygen from the wastewater may be adjusted to an appropriate value to remove the dissolved oxygen from the wastewater by monitoring the degree of decomposition of the PFAS.

Operation S40 of removing the dissolved oxygen from the wastewater may reduce or prevent hydration electrons (e⁻) generated when operation S50 of radiating ultraviolet rays to the wastewater is performed from being removed by reacting with the dissolved oxygen, thereby more efficiently removing the PFAS from the wastewater.

Thereafter, in order to generate hydration electrons (e⁻) by radiating the ultraviolet rays to the wastewater and decomposing the PFAS in the wastewater through a chain oxidation-reduction reaction derived from the hydration electrons (e⁻), operation S50 of radiating the ultraviolet rays to the wastewater may be performed. The PFAS may include Bis(1,1,2,2,3,3,4,4,4-nonafluoro-1-butanesulfonyl)imide.

The ultraviolet rays may have a wavelength within the range of about 200 nm to about 280 nm, for example, about 250 nm to about 260 nm or about 254. The ultraviolet rays may be radiated at an intensity within the range of about 20 W/cm² to about 30 W/cm² or about 30 W/cm² to about 40 W/cm². However, the intensity of the ultraviolet rays may be appropriately adjusted by monitoring the degree of decomposition of the PFAS. The ultraviolet rays may be radiated within the range of about 5 minutes to about 120 minutes or about 10 minutes to about 150 minutes. In some embodiments, the time for radiating the ultraviolet rays may be longer than the time for introducing and mixing the reducing agent, the time for introducing and mixing the pH adjusting agent, and the time for removing the dissolved oxygen from the wastewater. However, the time for radiating the ultraviolet rays may be appropriately adjusted by monitoring the degree of decomposition of the PFAS.

The ultraviolet rays may react with sulfite ions (SO₃²⁻) in the wastewater and generate hydration electrons (e⁻). When the ultraviolet rays are radiated, sulfite ions (SO₃²⁻) may form sulfite radicals (SO₃⋅⁻) and hydration electrons (e⁻), the hydration electrons (e⁻) may cause a chain oxidation-reduction reaction with the PFAS and water (H₂O), and the PFAS may be decomposed by the chain oxidation-reduction reaction. For example, the generated hydration electrons (e⁻) may cause the chain oxidation-reduction reaction with Bis(1,1,2,2,3,3,4,4,4-nonafluoro-1-butanesulfonyl)imide and water (H₂O), and the Bis(1,1,2,2,3,3,4,4,4-nonafluoro-1-butanesulfonyl)imide may be decomposed by the chain oxidation-reduction reaction.

Thereafter, operation S60 of storing the final treated water may be performed. The final treated water may be treated water from which the PFAS is removed from the initial wastewater. For example, the final treated water may be treated water from which Bis(1,1,2,2,3,3,4,4,4-nonafluoro-1-butanesulfonyl)imide has been removed from the initial wastewater. In other words, the final treated water may have a lower concentration of the PFAS than the initial wastewater. For example, the final treated water may have a lower concentration of Bis(1,1,2,2,3,3,4,4,4-nonafluoro-1-butanesulfonyl)imide than the initial wastewater.

According to the wastewater treatment method according to embodiments, wastewater including the PFAS may be treated by decomposing the PFAS in the wastewater without generating waste such as waste activated carbon and waste concentrated water, and environmental pollution caused by the wastewater may be eliminated.

While the disclosure has been particularly shown and described with reference to embodiments thereof, it will be understood that various changes in form and details may be made therein without departing from the spirit and scope of the following claims.

What is claimed is:

1. A wastewater treatment apparatus comprising:
a wastewater storage assembly configured to store wastewater comprising per- and polyfluoroalkyl substances (PFAS);
a reducing agent mixer configured to introduce and mix a reducing agent into the wastewater;
a pH adjuster configured to introduce a pH adjusting agent into the wastewater to adjust a pH of the wastewater;
a dissolved oxygen remover configured to remove dissolved oxygen from the wastewater;
a reactor configured to radiate ultraviolet rays to the wastewater and decompose the PFAS in the wastewater; and
a final treated water storage assembly configured to store the wastewater in which the PFAS have been decomposed.

2. The wastewater treatment apparatus of claim 1, wherein the PFAS comprises Bis(1,1,2,2,3,3,4,4,4-nonafluoro-1-butanesulfonyl)imide.

3. The wastewater treatment apparatus of claim 1, wherein the reducing agent comprises a sulfite compound.

4. The wastewater treatment apparatus of claim 1, wherein the reducing agent comprises sodium bisulfite (NaHSO₃), sodium sulfite (Na₂SO₃), potassium sulfite (K₂SO₃), potassium bisulfite (KHSO₃), ammonium sulfite ((NH₄)₂SO₃), ammonium bisulfite (NH₄HSO₃), calcium sulfite (CaSO₃), or a combination thereof.

5. The wastewater treatment apparatus of claim 1, wherein the pH adjuster is configured to adjust the pH of the wastewater to within a range of about 7 to about 14.

6. The wastewater treatment apparatus of claim 1, wherein the pH adjusting agent comprises a basic compound.

7. The wastewater treatment apparatus of claim 1, wherein the pH adjusting agent comprises sodium hydroxide (NaOH), calcium hydroxide (Ca(OH)₂), potassium hydroxide (KOH), ammonia water (NH₄OH), magnesium hydroxide (Mg(OH)₂), barium hydroxide (Ba(OH)₂), or a combination thereof.

8. The wastewater treatment apparatus of claim 1, wherein the dissolved oxygen remover is configured to aerate nitrogen gas at a rate of about 0.2 kg/min to about 0.3 kg/min per 1 m³ of the wastewater.

9. The wastewater treatment apparatus of claim 1, wherein the reducing agent is introduced at a concentration of about 5 mM to about 20 mM.

10. The wastewater treatment apparatus of claim 1, wherein the ultraviolet rays are radiated at about 20 W/cm² to about 30 W/cm².

11. A wastewater treatment apparatus comprising:
a wastewater storage assembly configured to store wastewater;
a reducing agent mixer configured to introduce and mix a reducing agent comprising a sulfite compound into the wastewater;
a pH adjuster configured to add a pH adjusting agent to the wastewater to adjust a pH of the wastewater to an alkaline level;
a dissolved oxygen remover configured to aerate nitrogen gas into the wastewater to remove dissolved oxygen;
a reactor configured to radiate ultraviolet rays to the wastewater to decompose specific substances in the wastewater; and
a final treated water storage assembly configured to store the wastewater in which the specific substances have been decomposed.

12. The wastewater treatment apparatus of claim 11, wherein the specific substances in the wastewater comprise per- and polyfluoroalkyl substances (PFAS).

13. The wastewater treatment apparatus of claim 11, wherein the reducing agent comprises sodium sulfite (Na₂SO₃).

14. The wastewater treatment apparatus of claim 11, wherein the reducing agent is introduced at a concentration of about 5 mM to about 20 mM.

15. The wastewater treatment apparatus of claim 11, wherein the pH adjusting agent comprises sodium hydroxide (NaOH).

16. The wastewater treatment apparatus of claim 11, wherein a hydraulic retention time (HRT) of the wastewater in the reactor is longer than an HRT of the wastewater in each of the reducing agent mixer, the pH adjuster, and the dissolved oxygen remover.

17. The wastewater treatment apparatus of claim 11, wherein the dissolved oxygen remover is configured to aerate nitrogen gas at a rate of about 0.2 kg/min to about 0.3 kg/min per 1 m³ of the wastewater for about 5 minutes to about 120 minutes.

18. A wastewater treatment apparatus comprising:
a wastewater storage assembly configured to store wastewater comprising Bis(1,1,2,2,3,3,4,4,4-nonafluoro-1-butanesulfonyl)imide;
a reducing agent mixer configured to introduce and mix a reducing agent comprising a sulfite compound into the wastewater;
a reactor configured to radiate ultraviolet rays to the wastewater to decompose the Bis(1,1,2,2,3,3,4,4,4-nonafluoro-1-butanesulfonyl)imide in the wastewater; and
a final treated water storage assembly configured to store the wastewater in which the Bis(1,1,2,2,3,3,4,4,4-nonafluoro-1-butanesulfonyl)imide has been decomposed.

19. The wastewater treatment apparatus of claim 18, further comprising a pH adjuster configured to add a pH adjusting agent to the wastewater to adjust a pH of the wastewater to an alkaline level.

20. The wastewater treatment apparatus of claim 18, further comprising a dissolved oxygen remover configured to aerate nitrogen gas into the wastewater to remove dissolved oxygen.
